(19) United States
(12) Patent Application Publication
(10) Pub. No.: US 2025/0128256 A1
(43) Pub. Date: Apr. 24, 2025

(54) MICROFLUIDIC DEVICES WITH AUTONOMOUS DIRECTIONAL VALVES

(71) Applicant: President and Fellows of Harvard College, Cambridge, MA (US)

(72) Inventors: Mohamed Yafia Okba Salem, Cambridge, MA (US); Donald E. Ingber, Cambridge, MA (US)

(73) Assignee: President and Fellows of Harvard College, Cambridge, MA (US)

(21) Appl. No.: 18/832,923

(22) PCT Filed: Jan. 24, 2023
(86) PCT No.: PCT/US2023/011473

§ 371 Date: Jul. 24, 2024

Related U.S. Application Data
(60) Provisional application No. 63/302,876, filed on Jan. 25, 2022.

(51) Int. Cl. B01L 3/00

(52) U.S. Cl. CPC B01L 3/502738; B01L 2200/0673; B01L 2400/0688

(57) ABSTRACT

Devices and methods related to microfluidic devices with autonomous directional valves are generally described.

### RELATED APPLICATIONS

This application claims priority under 35 U.S.C. § 119(e) to U.S. Provisional Patent Application No. 63/302,876, filed Jan. 25, 2022, which is incorporated herein by reference in its entirety for all purposes.

### TECHNICAL FIELD

Devices and methods related to microfluidic devices with autonomous directional valves are generally described.

### BACKGROUND

To perform controlled operations, conventional microfluidic devices employ valves requiring active mechanical or electromechanical elements, actuators, and/or controllers as well as external linked power sources. Such configurations limit the current microfluidic platforms from having a large number of valves that can enable numerous complex fluidic operations, and also increases the number of peripheral devices and production costs, therefore limiting the applicability of the devices. Moreover, applications like diagnostics and point of care testing require advanced automation with minimal peripherals.

### SUMMARY

Devices and methods related to microfluidic devices with autonomous directional valves are generally described. The subject matter of the present disclosure involves, in some cases, interrelated products, alternative solutions to a particular problem, and/or a plurality of different uses of one or more systems and/or articles.

According to some embodiments, a microfluidic device is described, the microfluidic device comprising a control channel, a reservoir, a directional valve fluidly connected to the control channel, and a stop valve disposed along a flow path extending from the reservoir to the directional valve, wherein the directional valve is configured to prevent liquid flow through the directional valve from the control channel, and wherein the directional valve is configured to permit gas flow through the directional valve into the control channel.

In certain embodiments, a microfluidic device comprises a control channel, a plurality of cascading reservoirs positioned in series and fluidly connected to the control channel, wherein each cascading reservoir includes a reservoir and a directional valve fluidly connected to the control channel. In some embodiments, the microfluidic device comprises a stop valve disposed along a flow path extending from the reservoir to the directional valve, wherein the directional valve is configured to prevent liquid flow through the directional valve from the control channel, and the directional valve is configured to permit gas flow through the directional valve into the control channel.

According to certain embodiments, a method is described, the method comprising flowing a control liquid from a first upstream portion of a control channel to a second downstream portion of the control channel to expose a directional valve to an external atmosphere, flowing a gas plug through the directional valve, and flowing a process liquid along a flow path fluidly connected to the directional valve as the gas plug flows through the directional valve.

Other advantages and novel features of the present disclosure will become apparent from the following detailed description of various non-limiting embodiments when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment shown where illustration is not necessary to allow those of ordinary skill in the art to understand. In the figures:

FIG. 1A shows, according to some embodiments, a schematic diagram of a microfluidic device comprising a control channel, a directional valve, and a reservoir;

FIG. 1B shows, according to some embodiments, a schematic diagram of the directional valve shown in FIG. 1A;

FIG. 2A-2D show, according to some embodiments, a method of fabricating a microfluidic device;

FIG. 3 shows, according to some embodiments, a schematic diagram of a microfluidic device comprising a control channel and a plurality of cascading reservoirs; and

FIG. 4 shows, according to some embodiments, a schematic diagram of a microfluidic device depicting a method of flowing a control liquid and a process liquid.

### DETAILED DESCRIPTION

Microfluidics systems that are used to enable miniaturization of devices and instruments require advanced levels of automation and active control elements to execute sequential complex operations needed for performing chemical and biological assays. Microfluidic valves are the main components needed to automate microfluidic operations. The valves are used to stop fluid flow and restart the flow again in a timed stepped manner, which helps in performing complex microfluidic operations such as moving samples and reagents to different locations of the microfluidic system and performing incubation and mixing steps.

Commonly used conventional valves require mechanical moving parts to control the fluid flow, which can be actuated manually or using solenoid actuators that need multiple electrical connections, controllers, and/or power sources. Other conventional valves, such as pneumatic valves, can control fluid flow by applying positive pressure on an elastic pneumatic channel that can block flow in a hydraulic channel. These valves can automate many operations, but require a larger number of pneumatic connections and external peripherals. Mechanical microvalves use internal moving structures to control fluid flow, but require connections to external pressure sources to control the internal moving structures inside each valve. Electro-actuated valves have been introduced to microfluidic systems to enable liquid flow without pumps, but the electro-actuated valves still require external electrical connections. In summary, the aforementioned valves used in conventional microfluidic devices require mechanical moving parts, controllers, pressure sources, and/or power source to facilitate fluid flow.

The Inventors have realized and appreciated that microfluidic devices comprising passive directional valves can be configured to automate complex microfluidic operations without any external peripherals or electrical connections. In some embodiments, a microfluidic device may comprise a control channel configured to facilitate the flow of a control liquid, a reservoir, a directional valve fluidly connected to the control channel, and a stop valve (e.g., a first stop valve) disposed along a flow path extending from the reservoir to the directional valve. The reservoir may be fluidly connected to the directional valve via a channel.

The directional valve may be configured to prevent liquid flow through the directional valve from the control channel and to permit gas flow through the directional valve from the first stop valve. Configuring the device in this way advantageously allows for the ability to flow the control liquid in the control channel from a first position upstream from the directional valve to a second position downstream from the directional valve to expose the directional valve to an external atmosphere through the control channel. Exposing the directional valve to the external atmosphere though the control channel allows the directional valve to act as a vent valve, therefore permitting a gas plug disposed in the flow path extending from the reservoir to the directional valve to vent through the directional valve. The gas plug may be one or more gases positioned in at least a portion of a valve, channel, and/or reservoir of the microfluidic system. As the gas plug vents from the directional valve, a liquid (e.g., a process liquid) disposed in the microfluidic device flows from the reservoir to a stop valve (e.g., a second stop valve) disposed between the directional valve and the flow path. Exposing the directional valve to an external atmosphere (e.g., by flowing the control liquid past the directional valve) therefore acts a triggering event to release the gas plug and flow the process liquid. Absent the triggering event, the pressure of the process liquid is sufficient to prevent flow by itself and/or in combination with a stop valve, as explained herein in further detail. Configuring the microfluidic device in this way allows process liquids (e.g., sample and/or reagent liquids) to stop and flow in a predetermined manner based on the design of the directional valve and indirect changes in pressure that result from flowing the control liquid in the control channel.

The directional valve may have any of a variety of suitable configurations to function as described above, e.g., to prevent liquid flow from the control channel and to permit gas flow from the first stop valve. In some embodiments, for example, at least a portion of the directional valve fluidly connected to the control channel may be angled with a relatively small opening that prevents liquid flow and permits gas flow. Accordingly, the portion of the directional valve may function as a liquid stop valve when the portion of the directional valve is exposed to a control liquid or as a gas vent valve when the portion of the directional valve is not exposed to the control liquid (e.g., when the control liquid has been flowed downstream from the directional valve).

In some embodiments, a directional valve may have several functions during filling and/or running of the microfluidic device. As explained above, for example, the directional valve may act as a stop valve to prevent a control liquid from flowing into the gas plug in the directional valve, therefore separating the control liquid from the sample reservoirs, reagent reservoirs, and/or channels. When the sample reservoirs and/or reagent reservoirs are being filled, the directional valve is designed to retain a high capillary pressure to keep the control liquid pinned at the directional valve, which avoids the samples and/or reagents from pushing the gas plug, therefore advantageously preventing drainage of the gas plug through the directional valve before the designed drainage time. While running the microfluidic device, a pump (e.g., a paper pump) can be connected to the control channel to flow the control fluid, and, as explained above, a directional valve that is exposed to an external atmosphere may act as a vent valve to drain the gas plug trapped between the control channel and the sample reservoir and/or reagent reservoir. In some embodiments, the geometry of the control channel and directional valve may be designed to flow the control liquid from the upstream portion of the control channel to the downstream portion of the control channel, therefore exposing the directional valve to an external atmosphere without exposing one or more other directional valves that are trapping a gas plug. In some embodiments, for example, the geometry of the control channel and the directional valve may be adjusted to ensure that only the directional valve exposed to the external atmosphere will drain and all other directional valves will keep the control liquid pinned. The geometry of the control channel and the directional valve therefore allows for the sequential drainage of the gas plugs through the directional valves in the same direction that the control fluid in the control channel is being emptied (e.g., by the pump). In some embodiments, for example, the control channel can be designed with dimensions with a comparatively lower capillary pressure than the directional valves so that the gas plug drainage is always at the liquid front of the directional valve exposed to the control channel. The directional valve may be designed with a cross-section exposed to the control channel that can drain laterally when the cross-section of the directional valve is combined with the cross-section of the control channel to make a larger combined cross-section that can be easily drained and prevent drainage of the other directional valves. Design issues and/or operational problems may occur if the capillary pressure of the combined cross-section area between the control channel and the directional valve is not bigger than the capillary pressure of the cross-section area of the other directional valves exposed to the gas plugs arranged along the control channel. According to some embodiments, the capillary pressure at the combined cross-section area that includes the control channel cross-section area and the directional valve cross-section area in the direction normal to the control channel may be lower than the directional valve cross-section area in the direction parallel to the control channel and exposed to the gas plug. The flow rate in the control channel may be adjusted to make sure that the control channel can act as a timer to adjust the drainage time of each directional valve, which controls the timing of drainage of the gas plug and enables sample and/or reagent flow at different time points.

In certain embodiments, the reservoir of the microfluidic device may be fluidly connected to a sample inlet with the first stop valve disposed between the sample inlet and the reservoir. The first stop valve may therefore be a stop valve for samples and/or reagents in the reservoir. For example, the sample fluid disposed in the sample inlet may be inhibited from flowing into the reservoir due to the first stop valve. When the control liquid is flowed downstream from the directional valve to expose the directional valve to an external atmosphere and release the gas plug, the liquid disposed in the sample inlet bursts the first stop valve and flows into the reservoir due to an increase in negative pressure that causes the liquid to displace the gas plug released into the control channel via the directional valve.

The design of the directional valve as explained above may be employed in a microfluidic device that includes a control channel and a plurality of cascading reservoirs disposed in series and fluidly connected to the control channel. In some embodiments, for example, each cascading reservoir may include a reservoir, a directional valve fluidly connected to the control channel, and a stop valve (e.g., a first stop valve) disposed along a flow path extending from the reservoir to the directional valve. Each reservoir of the cascading reservoirs may be fluidly connected to the respective directional valve via a channel. In certain embodiments, the channel may include a stop valve (e.g., a third stop valve) positioned between the channel and the next reservoir of the cascading reservoirs positioned in series along the control channel. Configuring the microfluidic device in this way allows a fluid to flow into the first reservoir (e.g., the first reservoir of the plurality of cascading reservoirs) when the control liquid is flowed in the control channel downstream from the first directional valve (e.g., of the first cascading reservoir), but inhibits the fluid from flowing into the second reservoir (e.g., the second reservoir of the plurality of cascading reservoirs) until the control liquid is flowed downstream from the second directional valve (e.g., of the second cascading reservoir) and the second directional valve is exposed to an external atmosphere through the control channel. The microfluidic device may be constructed such that the number of cascading reservoirs is suitable for the specific application of the device.

While any appropriate construction may be used, the microfluidic devices described herein may, in some embodiments, be fabricated using one or more patterned films wherein each film has at least a portion of a profile of a desired portion of the microfluidic device (e.g., a channel, a reservoir, a valve, other microfluidic components) formed in the one or more patterned films. The one or more patterned films may be stacked together (e.g., bonded) to form the microfluidic device. In certain embodiments, for example, the device may comprise a substrate, one or more patterned intermediate layers that define a plurality of passive elements (e.g., channels, reservoirs, valves, other microfluidic components), and a top layer to cover the microfluidic device. In some embodiments, certain portions of the device may be rendered hydrophilic or hydrophobic depending on the material used to fabricate the device, thereby assisting or inhibiting fluid flow at specific locations within the device. However, other fabrication techniques may be used to provide the microfluidic devices described herein, as the disclosure is not so limited. In some embodiments, for example, the microfluidic devices may be made with typical additive and/or subtractive manufacturing techniques (e.g., 3D-printing). In certain embodiments, the microfluidic devices may be fabricated by hot embossing, injection molding, and/or laser cutting. Other fabrication techniques are also possible.

Advantageously, the microfluidic devices described herein (e.g., fabricated using individual layers to form different portions of the microfluidic components, fabricated using additive manufacturing) are capable of direct use (e.g., in assays) with the native contact angles of the materials (e.g., polymers, plastics) used to fabricate the device, without the need for any hydrophilic and/or hydrophobic surface treatment. In some embodiments, the microfluidic devices are robust and capable of handling a wide array of liquids, samples, and reagents, even those with low surface tensions.

The pressure difference between each of the directional valves and/or stop valves may be provided by the design of the microfluidic device since the pressure can be controlled by the valve geometry and surface chemistry. In some embodiments, for example, the burst pressure of the stop valves can be controlled by adjusting the dimensions of the channel and varying the design between stepped and ramped configurations wherein the burst pressure of the stop valve is inversely proportional with the stop valve dimension. Surface coatings and/or other surface modifications may also be used either alone or in combination with channel geometry design to provide a stop valve.

The microfluidic devices disclosed herein can be used for performing various types of advanced operations without any additional peripherals, connections, or controllers, thereby allowing discrete, simultaneous, and sequential operations. The devices described herein can enable complex operations to be carried out with the device, thereby providing true lab-on-a-chip applications that can, for example, process logic gates encoded in the design of the microfluidic device, such as AND, OR, NOT gates that represent the basic building blocks of microprocessors, without requiring any surface treatment or mechanical and/or electromechanical actuators, interfaces, and/or external power sources. In some embodiments, the microfluidic devices are used for bioassays and/or biosensing applications in which multiple incubation steps are needed with defined timed steps.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

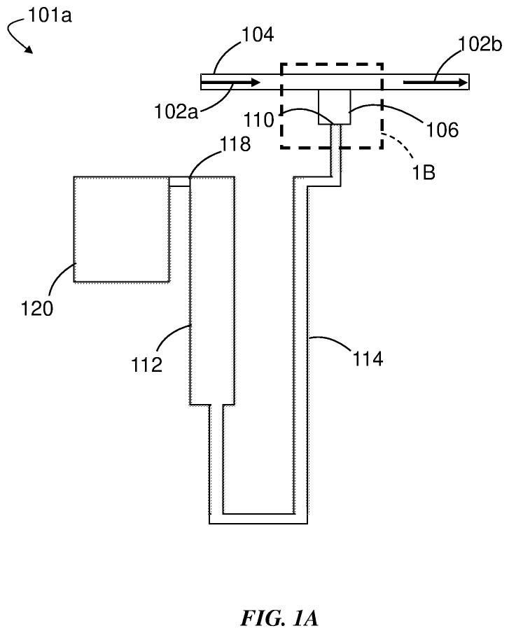

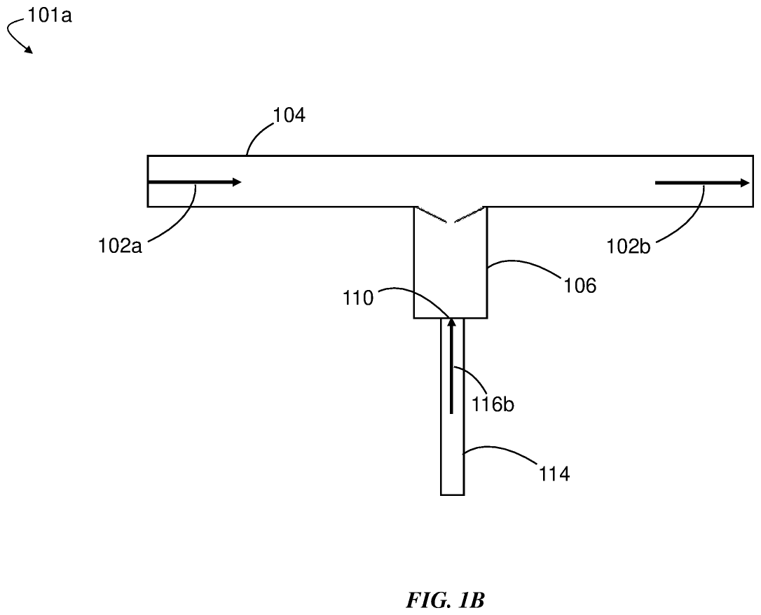

FIG. 1A shows, according to some embodiments, a schematic diagram of a microfluidic device. In some embodiments, microfluidic device 101a comprises control channel 104. Control channel 104 may be configured to facilitate the flow of a control liquid, for example, from upstream portion 102a of control channel 104 to downstream portion 102b of control channel 104.

In certain embodiments, microfluidic device 101a comprises directional valve 106 fluidly connected to control channel 104. The configuration and function of the directional valve is explained in greater detail herein.

According to certain embodiments, microfluidic device 101a comprises reservoir 112. A flow path may, in some embodiments, extend from reservoir 112 to directional valve 106. In certain embodiments, the flow path includes channel 114. The flow path may, in some embodiments, be configured to facilitate the flow a liquid (e.g., a process liquid, such as a sample and/or reagent liquid). In certain embodiments, for example, the flow path may extend from first stop valve 118 to directional valve 106 through reservoir 112 and channel 114 fluidly connected to first stop valve 118 and directional valve 106. Reservoir 112 and/or channel 114 may have any of a variety of suitable shapes, configurations, and/or directions, as the disclosure is not meant to be limiting in this regard. In some embodiments, for example, the area and/or length of reservoir 112 and/or channel 114 may be designed such that the timing and/or other process associated with the delivery of a process liquid to a certain location within the microfluidic device is appropriately configured for one or more particular applications. As explained in further detail herein, reservoir 112 and/or channel 114 may have one or more samples and/or reagents (e.g., dried samples and/or reagents) disposed within reservoir 112 and/or channel 114.

According to some embodiments, microfluidic device 101a comprises stop valve 118 (e.g., first stop valve). In certain embodiments, first stop valve 118 is disposed along the flow path extending from reservoir 112 to directional valve 106. Stop valve 118 may be configured to inhibit the flow of a liquid (e.g., a process liquid) from entering the flow path extending from reservoir 112 to directional valve 106 until a triggering event occurs, as explained in further detail below. In some embodiments, for example, the presence of a gas plug positioned in the flow path (e.g., upstream from directional valve 106 and downstream from first stop valve 118) may be insufficient to inhibit the flow of a process liquid and stop valve 118 may be used. Stop valve 118 may, in some embodiments, act as a stopping location without any specific geometry or design modifications if the capillary pressure at stop valve 118 is lower than the capillary pressure at directional valve 106. In some embodiments, stop valve 118 may be configured to selectively open due to a pressure drop across the stop valve.

In some embodiments, microfluidic device 101a comprises stop valve 110 (e.g., second stop valve). Second stop valve 110 may, in certain embodiments, be disposed along the flow path extending from reservoir 112 to directional valve 106 at a location between directional valve 106 and fist stop valve 118. As shown in FIG. 1A, for example, second stop valve 110 is disposed between channel 114 and directional valve 106. In some embodiments, second stop valve 110 is configured to inhibit the flow of a liquid (e.g., a process liquid) from entering the gas plug in directional valve 106.

FIG. 1B shows, according to some embodiments, a schematic diagram of the directional valve shown in FIG. 1A. As shown in FIG. 1B, directional valve 106 is fluidly connected to control channel 104. In some embodiments, directional valve 106 may have any of a variety of suitable configurations to achieve the function of preventing liquid flow into the gas plug in the directional valve and permitting gas flow through the directional valve. FIG. 1B shows, for example, that a portion of directional valve 106 fluidly connected to control channel 104 may be angled with a small opening that is configured to: (i) prevent liquid flow into the gas plug in the directional valve; and (ii) permit gas flow as the gas plug is drained into the control channel, as explained herein. The portion of directional valve 106 fluidly connected to control channel 104 may, in some embodiments, be angled in a triangular configuration, as shown in FIG. 1B, although other configurations are also possible as the disclosure is not meant to be limiting in this regard. In some embodiments, the geometric configuration and small opening of the portion of directional valve 106 fluidly connected to control channel 104, in conjunction with the presence of the gas plug, may prevent a liquid flowing in control channel 104 from entering directional valve 106. In certain embodiments, for example, when the portion of directional valve 106 fluidly connected to control channel 104 is exposed to a control liquid through control channel 104, the portion of directional valve 106 functions as a stop valve that inhibits the control liquid from entering directional valve 106.

Directional valve 106 may, in certain embodiments, be configured to permit gas flow through directional valve 106 (e.g., from first stop valve 118, shown in FIG. 1A). According to some embodiments, when the portion of directional valve 106 fluidly connected to control channel 104 is exposed to an external atmosphere through control channel 104, the portion of directional valve 106 acts as a vent valve that releases a plug of gas positioned upstream from directional valve 106 and downstream from first stop valve 118. Depending on the embodiment, the gas plug may correspond to one or more gasses present in the microfluidic device along at least a portion of a flow path extending between the reservoir and directional valve. In some embodiments, the configuration and small opening of the portion of directional valve 106 fluidly connected to control channel 104 may permit gas flow through directional valve 106. Releasing the plug of gas may, in some embodiments, facilitate the flow of a liquid (e.g., a process liquid) from, for example, reservoir 112 to second stop valve 110 to displace the released gas plug. Exposing the portion of directional valve 106 fluidly connected to control channel 104 to an external atmosphere therefore acts a triggering event that releases the gas plug and facilities flow of the process liquid. Without the triggering event, the pressure of the process liquid and/or a stop valve prevents flow of the process liquid in the microfluidic device.

Referring to FIG. 1A, reservoir 112 may be fluidly connected to sample inlet 120, according to some embodiments. In certain embodiments, stop valve 118 (e.g., first stop valve) is disposed between reservoir 112 and sample inlet 120. In certain embodiments, first stop valve 118 and directional valve 106 are designed to ensure that the capillary pressure at directional valve 106 is higher than the capillary pressure at first stop valve 118, which advantageously pins the control liquid at directional valve 106, traps the gas plug in reservoir 112 and/or channel 114, and stops the process liquid at first stop valve 118. In certain embodiments, when directional valve 106 is exposed to an external atmosphere through control channel 104, a pressure drop may occur in the flow path extending from first stop valve 118 to directional valve 106 through reservoir 112 and channel 114 fluidly connected to first stop valve 118 and directional valve 106. A liquid disposed in sample inlet 120 (e.g., a process fluid) may, in some embodiments, burst first stop valve 118 and flow from sample inlet 120 to reservoir 112 and to second stop valve 110 because of the gas plug being released from a position upstream from directional valve 106 and downstream from first stop valve 118. For example, when directional valve 106 is exposed to the external atmosphere and the gas plug is drained into control channel 104, directional valve 106 acts as a vent valve and the capillary pressure generated at first stop valve 118 facilitates the flow of the gas plug through directional valve 106, and the process liquid displaces the gas plug in reservoir 112 and channel 114.

According to certain embodiments one or more samples and/or reagents may be disposed in reservoir 112 and/or channel 114. In some embodiments, for example, one or more dried samples and/or reagents may be disposed in reservoir 112 and/or channel 114. When the process fluid flows from sample inlet 120 to reservoir 112 and to second stop valve 110, displacing the gas plug, the process fluid may dissolve and/or reconstitute the one or more dried samples and/or reagents disposed in reservoir 112 and/or channel 114. In certain embodiments, reservoir 112 and/or channel 114 may comprise one or more filters (e.g., paper filters) containing one or more dried samples and/or reagents. The filters may be placed in the reservoirs to be reconstituted sequentially when the process liquid flows into the reservoir and over the filters.

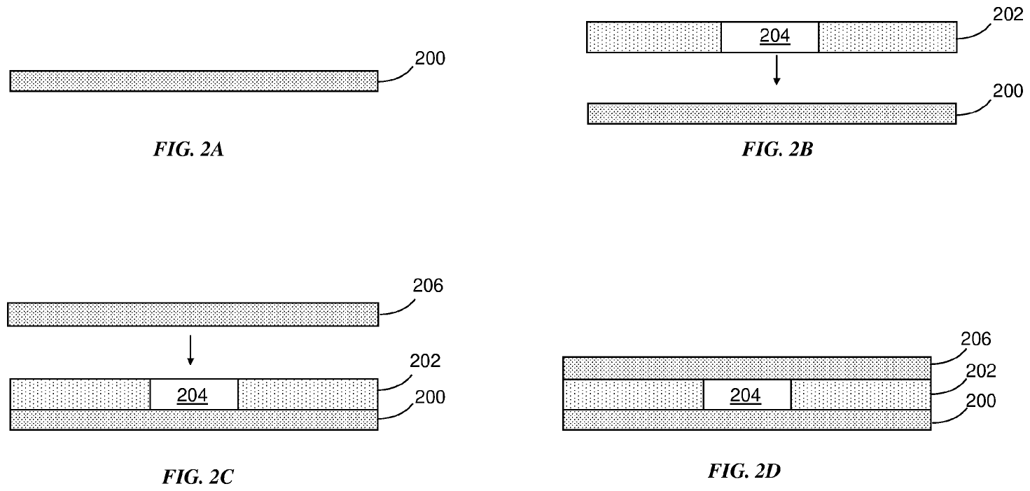

The microfluidic devices described herein may be fabricated by any of a variety of suitable means. In some embodiments, the microfluidic devices are fabricated using individual layers to form different portions of the microfluidic components. Such a fabrication method advantageously enables the use of different materials for various portions of a microfluidic device and facilitates the fabrication of devices with tailored geometries and/or surface properties. FIGS. 2A-2D show, according to some embodiments, a cross-sectional schematic diagram depicting a method of fabricating a microfluidic device. According to some embodiments, for example, a microfluidic device may comprise substrate 200, one or more intermediate layers 202, and top layer 206. In certain embodiments, one or more intermediate layers 202 of the microfluidic device may be patterned such that the one or more intermediate layers comprises one or more features 204 corresponding to a passive component of the microfluidic device (e.g., channels, valves, reservoirs, other microfluidic components).

Depending on the function of the feature (e.g., channel, valve, reservoir, other microfluidic component) formed in the one or more intermediate layers, the overall size, shape, and/or geometry of the feature may be tailored for a particular application. Such a configuration advantageously enables the fabrication of microfluidic devices that can be fine-tuned to perform advanced microfluidic operations, including sequential delivery and/or mixing of liquid samples and/or reagents, timed and/or stepped operations using sacrificial reservoirs that can act as timers, stopping and incubating liquid samples, and starting and stopping flow through a device using sacrificial reservoirs, by precisely controlling the capillary pressures at desired locations within the device. For example, although not shown in the figures, a microfluidic device may comprise more than one intermediate layer (e.g., two intermediate layers, three intermediate layers, four intermediate layers, etc.), and one or more features with a desired large geometry (e.g., cross-sectional dimension), such as a reservoir, channel, and/or stop valve with a low burst pressure, may be formed in more than one intermediate layer. In certain other embodiments, one or more features with a desired small geometry, such as a channel and/or stop valve with a large burst pressure, may be formed in one intermediate layer.

In some embodiments, one or more intermediate layers of the microfluidic device are manufactured with a set of corresponding patterns where portions of material have been removed. In certain embodiments, at least a portion of the patterns of the individual layers align with one another when stacked together such that the layers define a plurality of interconnected channels, reservoirs, valves, and/or other microfluidic components. The patterns of removed material in the intermediate layers may be formed, in some embodiments, by cutting, stamping, punching, and/or etching the patterns into the one or more intermediate layers. In certain non-limiting embodiments, for example, the patterns corresponding to the plurality of channels, reservoirs, valves, and/or other microfluidic components may be cut into the one or more intermediate layers using plot cutters and/or laser cutters, such as a Silhouette portrait craft cutter (Silhouette America, Lindon, UT) and/or a Graphtec Cutting Plotter CE-5000 (Graphtec America, Inc., Irvine, CA). Of course, any other appropriate method of forming a pattern in the one or more intermediate layers may also be used. In certain embodiments, for example, the patterns corresponding to the plurality of channels, reservoirs, and/or valves are formed in the one or more intermediate layers by additive manufacturing (e.g., 3D-printing). Different fabrication methods (e.g., cutting, stamping, punching, etching, additive manufacturing, etc.) of the one or more intermediate layers can affect the surface properties of the layer.

After forming the desired patterns in the one or more intermediate layers, the method may include applying the one or more intermediate layers to a substrate. Referring, for example, to FIGS. 2A and 2B, intermediate layer 202 comprising feature 204 is positioned over substrate 200 in a desired position and orientation prior to placing intermediate layer 202 in contact with substrate 200 such that intermediate layer 202 is disposed on substrate 200. As explained herein, feature 204 may correspond to a channel, reservoir, valve, and/or other microfluidic component. While not depicted, in some embodiments, one or more additional intermediate layers may also be positioned over and placed into contact with the first intermediate layer in a desired position and orientation such that they are disposed on the first intermediate layer on a surface of the first intermediate layer opposite from the substrate. Thus, complex microfluidic structures defined by interconnected patterns formed in multiple intermediate layers may be constructed. As shown in FIG. 2C, in certain embodiments, the method also includes positioning top layer 206 over a topmost one of one or more intermediate layers 202 in a desired position and orientation. Top layer 206 may then be placed into contact with the topmost one of one or more intermediate layers 202 such that one or more intermediate layers 202 are disposed between top layer 206 and substrate 202, as shown in FIG. 2D. Once assembled, the various microfluidic components such as channels, valves, reservoirs, and/or other microfluidic components may be formed between the surfaces of the stacked substrate, one or more intermediate layers, and top layer.

In some embodiments, the microfluidic devices described herein may be fabricated using methods described in U.S. patent application No. 63/047,012, filed Jul. 1, 2020, and entitled “Microfluidic Systems Containing Layers of Films,” and in U.S. patent application No. 63/302,832, filed Jan. 25, 2022, and entitled “Microfluidic Systems Containing Layers of Films,” which are incorporated herein by reference in their entirety.

As explained above, a microfluidic device as described herein may be configured with one or more stop valves. In some embodiments, the burst pressure of the stop valves can be controlled by adjusting the dimensions of the stop valve. For example, the dimensions of one or more features in the one or more intermediate layers corresponding to a stop valve may be adjusted in order to tune the burst pressure of the stop valve. In certain embodiments, the burst pressure of the stop valve is inversely proportional to the stop valve dimension, such that a stop valve with a smaller geometry requires a higher burst pressure to burst the stop valve as compared to a stop valve with a larger geometry.

In certain embodiments, regardless of the fabrication technique, the burst pressure of the stop valves can be controlled by varying the design of the stop valve between stepped and ramped configurations. In certain embodiments, for example, the intermediate layers of the microfluidic device may be configured such that there is a feature patterned into the intermediate layers comprising a stepped configuration between intermediate layers, thereby functioning as a stop valve due to the step change in height. In some embodiments, the feature formed by additive manufacturing may comprise a stepped configuration, thereby functioning as a stop valve due to the step change in height. In other embodiments, the feature patterned into the intermediate layers may comprise a ramped configuration between intermediate layers, thereby functioning as a stop valve due to the gradual change in height. In certain other embodiments, the feature formed by additive manufacturing may comprise a ramped configuration, thereby functioning as a stop valve due to the gradual change in height.

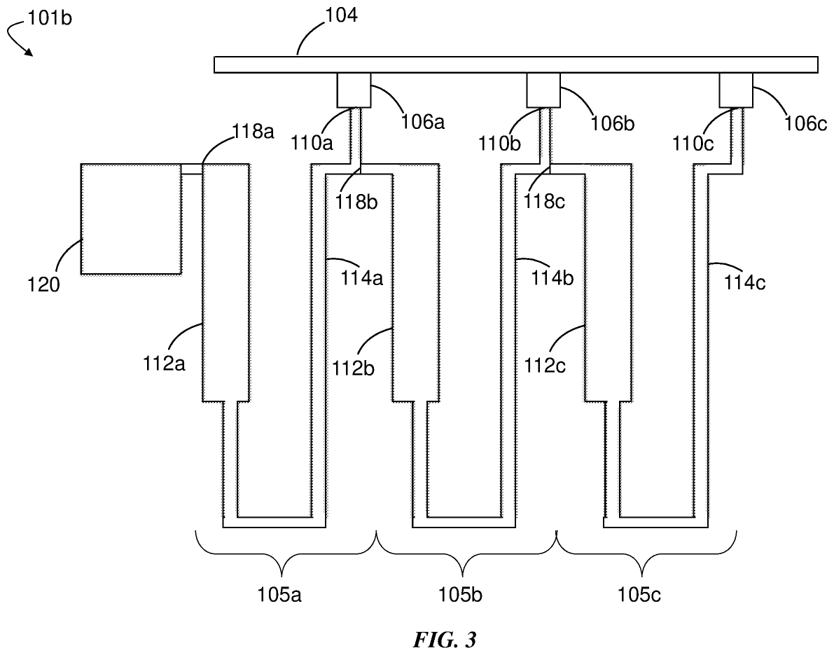

According to certain embodiments, a microfluidic device may be configured with a plurality of cascading reservoirs. FIG. 3 shows, according to some embodiments, a schematic diagram of microfluidic device 101b comprising control channel 104 and plurality of cascading reservoirs 105 (e.g., cascading reservoirs 105a-105c) positioned in series and fluidly connected to control channel 104. In some embodiments, each cascading reservoir 105 includes reservoir 112, directional valve 106 fluidly connected to control channel 104, first stop valve 118 disposed along a flow path extending from reservoir 112 to directional valve 106, and second stop valve 110 disposed along the flow path at a location between directional valve 106 and first stop valve 118.

According to some embodiments, each directional valve 106 (e.g., of each cascading reservoir 105) may be configured as explained herein, for example, to prevent liquid flow through directional valve 106 from control channel 104 and to permit gas flow through directional valve 106 from the flow path extending from first stop valve 118 to directional valve 106 through reservoir 112 and channel 114 fluidly connected to first stop valve 118 and directional valve 106. In some embodiments, a portion of each directional valve 106 fluidly connected to control channel 104 may function as a stop valve when exposed to a liquid (e.g., a control liquid) through control channel 104. In other embodiments, a portion of each directional valve 106 fluidly connected to control channel 104 may function as a vent valve when exposed to an external atmosphere through control channel 104 after flowing the control liquid from the first, upstream portion of the control channel to the second, downstream portion of the control channel. In some embodiments, when exposed to an external atmosphere through control channel 104, each directional valve 106 may release a plug of gas positioned upstream from directional valve 106 and downstream from first stop valve 118, which facilitates the flow of a liquid (e.g., a process liquid) from, for example, reservoir 112 to second stop valve 110.

According to certain embodiments, first cascading reservoir 105a of plurality of cascading reservoirs 105 is fluidly connected to sample inlet 120. In some such embodiments, first stop valve 118a of first cascading reservoir 105a is disposed between sample inlet 120 and reservoir 112a of first cascading reservoir 105a. When directional valve 106a of first cascading reservoir 105a is exposed to an external atmosphere through control channel 104, a gas plug positioned upstream from directional valve 106a and downstream from first stop valve 118a is released through directional valve 106a and a liquid disposed in sample inlet 120 flows from sample inlet 120 into reservoir 112 and to second stop valve 110a.

According to some embodiments, each cascading reservoir of the plurality of cascading reservoirs 105 is fluidly connected to a next cascading reservoir positioned in series along control channel 104. Referring, for example, to FIG. 3, cascading reservoir 105a is fluidly connected to cascading reservoir 105b, which is fluidly connected to cascading reservoir 105c. Although FIG. 3 shows three cascading reservoirs, a microfluidic device as described herein may comprise any appropriate number of cascading reservoirs for a particular application (e.g., four cascading reservoirs, five cascading reservoirs, etc.), as the disclosure is not meant to be limiting in this regard.

In certain embodiments, the flow path extending from reservoir 112 to the corresponding directional valve 106 of each cascading reservoir 105 may comprise channel 114. Referring, for example, to FIG. 3, the flow path extending from reservoir 112a to directional valve 106a of cascading reservoir 105a comprises channel 114a. According to some embodiments, each channel 114 of each cascading reservoir 105 may be fluidly connected to first stop valve 118 of the next cascading reservoir 105 positioned in series. Referring to FIG. 3, for example, channel 114a of cascading reservoir 105a is fluidly connected to first stop valve 118b of cascading reservoir 105b. In certain embodiments, stop valves may be used to control the flow of a process liquid between cascading reservoirs connected in series to one another. This may be embodied as a first stop valve fluidly connected to the channel fluidly connected to an upstream reservoir at a location between the upstream reservoir and the associated directional valve and stop valve pair used to vent the gas plug. This first stop valve may couple the channel of the upstream reservoir to one or more downstream reservoirs. For example, as shown in FIG. 3, first stop valve 118b of cascading reservoir 105b is fluidly connected to channel 114a of upstream reservoir 112a and a second downstream reservoir 112b at a location between the upstream reservoir and the associated pair of directional valve 106a and second stop valve 110a associated with the first upstream reservoir. This type of arrangement may be repeated for any number of sequentially arranged reservoirs in series and/or parallel configurations.

In certain embodiments, a sensor and/or detector may be integrated into and/or otherwise associated with the microfluidic device to evaluate one or more fluids (e.g., a process fluid). In some embodiments, for example, a sensor and/or detector may be integrated into one or more reservoirs such that a fluid flowing in the reservoir may flow over and/or past the sensor and/or detector. In certain embodiments, a sensor and/or detector may be associated with an outlet of the microfluidic device, for example, an outlet fluidly connected to a final cascading reservoir positioned in series in the plurality of cascading reservoirs. Suitable sensors include, but are not limited to, a chemical sensor (e.g., an electrochemical sensor), an optical sensor (e.g., UV-vis spectrometer, fluorescence spectrometer), and the like. The sensor may be used for the analysis of chemical or molecular components in one or more fluids (e.g., process fluids).

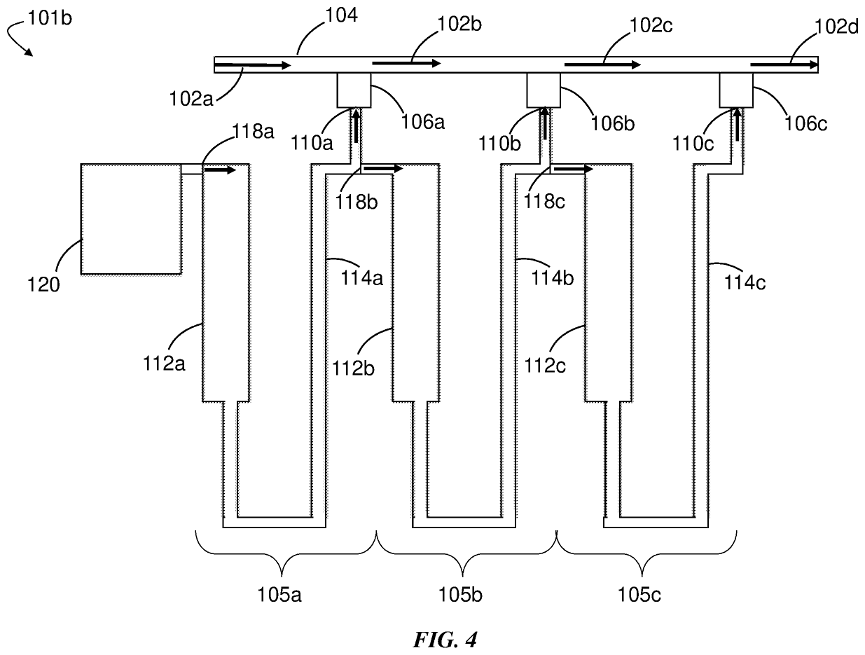

FIG. 4 shows, according to some embodiments, a schematic diagram of a microfluidic device depicting a method of flowing a control liquid and a process liquid. In some embodiments, a method comprises flowing a control liquid from first upstream portion 102a of control channel 104 to second downstream portion 102b of control channel 104. Flowing the control liquid from first upstream portion 102a to second downstream portion 102b may, in some embodiments, expose at least a portion of directional valve 106a fluidly connected to control channel 104 to an external atmosphere through control channel 104.

In certain embodiments, the method comprises flowing a gas plug through directional valve 106a. In certain embodiments, for example, as a result of exposing the portion of directional valve 106a fluidly connected to control channel 104 to an external atmosphere, a gas plug positioned upstream from directional valve 106a and downstream from first stop valve 118a may flow through directional valve 106a.

According to some embodiments, the method comprises flowing a process liquid along a flow path fluidly connected with the directional valve as the gas plug flows through the directional valve. For example, in certain embodiments, a process liquid may flow along a flow path extending from reservoir 112a to directional valve 106a to displace the gas plug flowing through directional valve 106a. In certain embodiments, flowing the process liquid comprises bursting a first stop valve disposed along the flow path and flowing the process liquid from the first stop valve to a second stop valve stop valve disposed along the flow path. For example, the process liquid (e.g., from sample inlet 120) may burst first stop valve 118a and flow from sample inlet 120 through first stop valve 118a to reservoir 112a. The process liquid may, in some embodiments, fill reservoir 112a.

In certain embodiments, the process liquid flows through channel 114a and contacts second stop valve 110a and first stop valve 118b (e.g., of cascading reservoir 105b). In some such embodiments, the process liquid may be in contact with first stop valve 118b of cascading reservoir 105b, therefore forming a gas plug in cascading reservoir 105b. In some embodiments, after contacting second stop valve 110a and first stop valve 118b, flow of the process liquid in cascading reservoir 105a is stopped.

According to certain embodiments, the method may be repeated for the next cascading reservoir (e.g., cascading reservoir 105b). For example, in some embodiments, a method comprises flowing the control liquid from the second downstream portion 102b of control channel 104 to a third further downstream portion 102c of control channel 104. In some embodiments, for example, the control liquid may be flowed upstream from directional valve 106b to downstream from directional valve 106b. As a result of flowing the control liquid, the portion of directional valve 106b fluidly connected to control channel 104 may be exposed to an external atmosphere through control channel 104, resulting in a gas plug positioned upstream from directional valve 106b and downstream from first stop valve 118b to flow through directional valve 106b. In some embodiments, the method comprises flowing the process liquid along a flow path fluidly connected with directional valve 106b as the gas plug flows through directional valve 106b. In some such embodiments, the process liquid that previously stopped at stop valve 118b may burst stop valve 118b and flow from first stop valve 118b to reservoir 112b, followed by flowing through channel 114b until the process fluid contacts second stop valve 110b and first stop valve 118c (e.g., of third cascading reservoir 105c). The method may be repeated for the next cascading reservoir (e.g., cascading reservoir 105c) such that the control liquid flows from third further downstream portion 102c to fourth further downstream portion 102d and the process liquid flows from stop valve 118c to stop valve 110c.

As explained herein, one or more reservoirs and/or channels of each cascading reservoir may, in some embodiments, comprise a sample and/or reagent. For example, in some embodiments, one or more reservoirs and/or channels may comprise a dried sample and/or reagent or a filter (e.g., a paper filter) comprising a dried sample and/or reagent. As the process liquid fills the reservoir and/or channel of each cascading reservoir, the process liquid may dissolve and/or reconstitute the sample and/or reagent.

The microfluidic devices described herein can be used, in some embodiments, for applications that require automated time stepped sampling and aliquoting of fluids. In some embodiments, for example, the plurality of cascading reservoirs can be used to aliquot fluids to discrete reservoirs by allowing the fluids to flow to each reservoir sequentially based on exposing the directional valves to an external atmosphere through the control channel, without adding any additional connections or peripherals to the microfluidic device. The design of the microfluidic device therefore enables sequential delivery of fluids using a valving system in a compact and reliable manner. The microfluidic device can be used, for example, for biosensing applications and/or assays. In certain embodiments, the microfluidic device may be used for portable diagnostics with clustered regularly interspaced short palindromic repeats (CRISPR), an automated enzyme-linked immunosorbent assay (ELISA), spectroscopic detection, and/or electrochemical detection.

### EXAMPLE

The following examples describes the use of a microfluidic device with autonomous directional valves to perform portable diagnostics with clustered regularly interspaced short palindromic repeats (CRISPR) and an automated enzyme-linked immunosorbent assay (ELISA).

A microfluidic device with a plurality of cascading reservoirs, similar to the microfluidic device shown in FIG. 3, was fabricated. The microfluidic device can be used to perform various types of operations that require multiple pre-programmed fluidic steps, such as performing biological assays. The device can be used in point of care testing since it does not require any controllers, valves, complex peripherals, or power sources to run the required fluidic operations. The device can hold reagents at each reservoir and flow them sequentially at different time points based on the design of the fluidic timers in the control channel. The samples and reagents can hydrate reagents (e.g., dried reagents) in the reservoirs, be mixed at different time steps, and flow over different reagents sequentially. Paper filters with dried reagents can be placed inside the reservoirs to be reconstituted sequentially when the liquid sample flows over them. The reagents can also be dried directly in the reservoirs and reconstituted at specific time points by the working liquids or samples.

The microfluidic device was used to perform multiple liquid operations for point of care diagnostics using CRISPR. The device can run various types of biological samples such as saliva, blood, or urine. The detection process has three steps: (i) lysis and extraction; (ii) isothermal amplification; and (iii) CRISPR reaction. The microfluidic device held dried reagents for the lysis step to extract the RNA from the sample in the first reservoir after the sample flowed, rehydrated, and mixed with the lysis reagents. The incubation time for the lysis step was controlled by a first timer in the control channel. The liquid then moved to the next step for RNA amplification. A recombinase polymerase amplification (RPA) step was used after the RNA extraction step. RPA reagents were dehydrated in the second reservoir. The liquid from the first reservoir was released after the first timer finished and was used to reconstitute the RPA reagents that mixed with the extracted RNA from the first step. The amplification step with RPA occurred at ambient temperatures without heating and the amplification time was controlled by a second timer in the control channel. Finally, the detection of the amplicons occurred in the last reservoir using CRISPR reagents located in the third reservoir. The liquid coming from the second reservoir, holding the amplicons, rehydrated and mixed with the dried CRISPR reagents. The CRISPR process started and the time was controlled by a third timer in the control channel. Simple readout methods were used to avoid using bulky or expensive equipment. The result was measured by fluorescence or a lateral flow assay that was connected to the last reservoir where the liquid flowed to a detector after the third timer ended.

The microfluidic device was also used to perform automated enzyme-linked immunosorbent assay (ELISA) steps. The sample flowed to reconstitute capture antibodies that were dehydrated in the first reservoir. The incubation time of the sample mixed with the capture antibodies was controlled by the first timer in the control channel. The mixture of the sample and the capture antibodies flowed to the second reservoir to reconstitute and mix with detection antibodies. The incubation time of this step was controlled by the second timer in the control channel. Any appropriate labels or enzymatic amplification steps can be added with additional reservoirs. Finally, a washing step was used to decrease the nonspecific binding. The readout method was performed by fluorescence or using electrochemical sensors or any appropriate measurement technique.

The microfluidic device as described herein can be fabricated using various techniques such as hot embossing, injection molding. 3D-printing, and/or laser cutting of films. Different materials can be used to fabricate the microfluidic device such as plastic polymers that can be hot embossed or injection molded, 3D-printing resins, and/or hydrophobic and/or hydrophilic films.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or.” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.c., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.c., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of,” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A microfluidic device, comprising:
a control channel;
a reservoir;
a directional valve fluidly connected to the control channel; and
a stop valve disposed along a flow path extending from the reservoir to the directional valve, wherein the directional valve is configured to prevent liquid flow through the directional valve from the control channel, and wherein the directional valve is configured to permit gas flow through the directional valve into the control channel.

2. The microfluidic device of claim 1, wherein the stop valve is a first stop valve, and the microfluidic device further comprises a second stop valve disposed along the flow path at a location between the directional valve and the first stop valve.

3. The microfluidic device of claim 2, wherein when the directional valve is exposed to an external atmosphere through the control channel, a liquid disposed in the reservoir flows from the reservoir to the second stop valve.

4. The microfluidic device of any one of claims 1-3, wherein the reservoir is fluidly connected to a sample inlet.

5. The microfluidic device of claim 4, wherein the first stop valve is disposed between the sample inlet and the reservoir.

6. The microfluidic device of any one of claims 4-5, wherein when the directional valve is exposed to an external atmosphere through the control channel, a liquid disposed in the sample inlet flows from the sample inlet to the reservoir and to the second stop valve.

7. The microfluidic device of any one of claims 1-6, wherein when the directional valve is exposed to a control liquid through the control channel, the directional valve functions as a stop valve.

8. The microfluidic device of any one of claims 1-4, wherein the flow path extending from the reservoir to the directional valve comprises a channel.

9. A microfluidic device, comprising:
a control channel;
a plurality of cascading reservoirs positioned in series and fluidly connected to the control channel, wherein each cascading reservoir includes:
a reservoir; and
a directional valve fluidly connected to the control channel; and
a stop valve disposed along a flow path extending from the reservoir to the directional valve, wherein the directional valve is configured to prevent liquid flow through the directional valve from the control channel, and the directional valve is configured to permit gas flow through the directional valve into the control channel.

10. The microfluidic device of claim 9, wherein the stop valve is a first stop valve and each cascading reservoir further comprises a second stop valve disposed along the flow path at a location between the directional valve and the first stop valve.

11. The microfluidic device claim 10, wherein when the directional valve is exposed to an external atmosphere through the control channel, a liquid disposed in the reservoir flows from the reservoir to the second stop valve.

12. The microfluidic device of any one of claims 9-11, wherein a first cascading reservoir of the plurality of cascading reservoirs is fluidly connected to a sample inlet.

13. The microfluidic device of claim 12, wherein the first stop valve of the first cascading reservoir is disposed between the sample inlet and the reservoir of the first cascading reservoir.

14. The microfluidic device of any one of claims 12-13, wherein when the directional valve of the first cascading reservoir is exposed to an external atmosphere through the control channel, a liquid disposed in the sample inlet flows from the sample inlet to the reservoir of the first cascading reservoir and the second stop valve of the first cascading reservoir.

15. The microfluidic device of any one of claims 9-14, wherein when the directional valve is exposed to a control liquid through the control channel, the directional valve functions as a stop valve.

16. The microfluidic device of any one of claims 9-15, wherein each cascading reservoir of the plurality of cascading reservoirs is fluidly connected to a next cascading reservoir positioned in series and/or parallel.

17. The microfluidic device of any one of claims 9-16, wherein the flow path extending from the reservoir of each cascading reservoir to the directional valve of each cascading reservoir comprises a channel.

18. The microfluidic device of claim 17, wherein the channel is fluidly connected to a first stop valve of the next cascading reservoir positioned in series.

19. The microfluidic device of claim 18, wherein the first stop valve of the next cascading reservoir is disposed between the channel and the next cascading reservoir positioned in series.

20. The microfluidic device of any one of claims 9-19, wherein one or more reservoirs of each cascading reservoirs comprises a dried sample and/or reagent disposed therein.

21. A method, comprising:
flowing a control liquid from a first upstream portion of a control channel to a second downstream portion of the control channel to expose a directional valve to an external atmosphere;
flowing a gas plug through the directional valve; and
flowing a process liquid along a flow path fluidly connected to the directional valve as the gas plug flows through the directional valve.

22. The method of claim 21, wherein the flow path includes a reservoir and a channel.

23. The method of any one of claims 20-22, wherein flowing the process liquid comprises flowing the process liquid from a first stop valve disposed along the flow path to a second stop valve stop valve disposed along the flow path.

24. The method of claim 23, wherein flowing the process liquid comprises bursting the first stop valve and flowing the process liquid through the reservoir to the second stop valve.

25. The method of any one of claims 20-24, wherein the directional valve is a first directional valve and the method comprises:
flowing the control liquid from the second downstream portion of the control channel to a third further downstream portion of the control channel;
flowing a gas plug through a second directional valve; and
flowing the process liquid along a flow path fluidly connected with the second directional valve as the gas plug flows through the second directional valve, wherein the second directional valve is fluidly connected to the channel of the flow path fluidly connected with the first directional valve.
